(19) United States
(12) Patent Application Publication
(10) Pub. No.: US 2009/0022837 A1
(43) Pub. Date: Jan. 22, 2009

(54) PNEUMATIC SOAP BAR EJECTOR QUICK CHANGE SYSTEM FROM MATRIX

(76) Inventor: EDUARDO JOSE COLLAZUOL, ROSARIO (AR)

Correspondence Address: FURR LAW FIRM, 2622 DEBOLT ROAD, UTICA, OH, 43080, US

(21) Appl. No.: 12/174,172

(22) Filed: Jul. 16, 2008

(30) Foreign Application Priority Data
Jul. 17, 2007 (AR) P 20070103177

(51) Int. Cl. B28B 13/06

(52) U.S. Cl. 425/139

(57) ABSTRACT

The invention allows for quickly changing the pneumatic ejection device of soap bars from the matrix. This is achieved by making it possible to remove the ejector without removing the matrix from the stamping machine, by simply releasing the cross bolt and injecting pressurized air, as usually done by the machine, in order to eject it, this way the ejector can be removed and cleaned or replaced and another ejector can be inserted into its housing along with the cross bolt, making the machine functional once again, avoiding wasted time, risks of accidents during handling and preserving the integrity of the matrix.

### TITLE AND TECHNICAL AREA

This invention refers to a quick-change system for pneumatic soapbar ejection devices from the main component.

The system mentioned is made up of a device and procedure used to make this quick change with the molding of a plastic mold, which is directly related to the manufacturing procedure and specifically related to the stamping or molding of the soap bars.

When we mention soap bars, it is understood more in a broad sense, considering the plastic material of the fabric, as well as the detergents and their mixtures, etc.

### STATE OF THE ART AND PROBLEMS TO SOLVE

A stamp mold system is used to shape the bars of soap. Dies are used in this process which are synthetically made up of two parts that will stamp the desired shape. In the matrices, the device that ejects the stamped bars from the cavity that holds it is activated through air pressure injection. This device then retracts to its original position, usually using a spring, but another method can also be used for this purpose.

These systems must be disassembled frequently for cleaning and when being replaced, since they usually have the brand or design of the bar of soap in bas-relief.

With the methods currently being used it is necessary to remove the matrix from the stamping machine in order to perform these tasks.

### BRIEF DESCRIPTION OF THE INVENTION

This is a pneumatic soap bar ejector quick change system from the matrix, where changing the ejector or cleaning it can be done while the matrices are still mounted on the machine. Also, in the system to be registered with this document, the set bolt acts as a safety measure, always holding the ejectors more in case the screws holding each one with a spring and cover accidentally become loose.

With this changing system used to change the ejection device, the cross bolt is removed, and stays released; after performing this process in reverse (placing the device in its housing and adding the bolt) it is installed.

### DESCRIPTION OF DRAWINGS

In order to make the purpose of the invention easier to understand it has been illustrated in three (3) figures, one shows the preferred methods of execution, which is kept as an example; and includes:

FIG. 1, is a perspective view and sectional view, allowing to see from above and below, the inside of the matrix and its internal components, basically, the holding system of the ejector with the cross bolt.

FIG. 2, is a cross-sectional view that shows the location of the parts and allows us to understand the system's operation.

FIG. 3, also includes a lengthwise view, which allows us to see the frontal position of the set bolt and the layout of the rest of the elements of the matrix that make up the operation of this system.

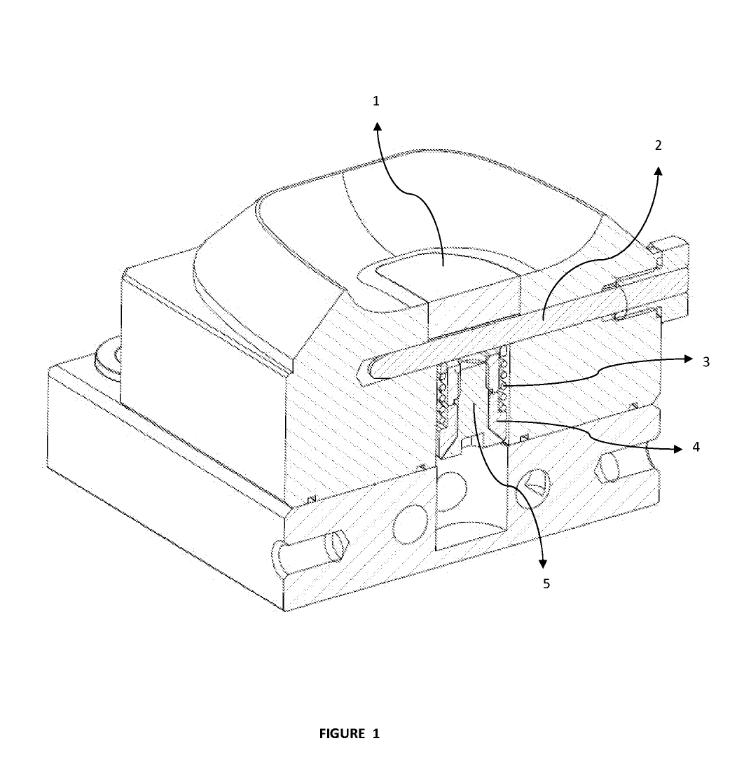

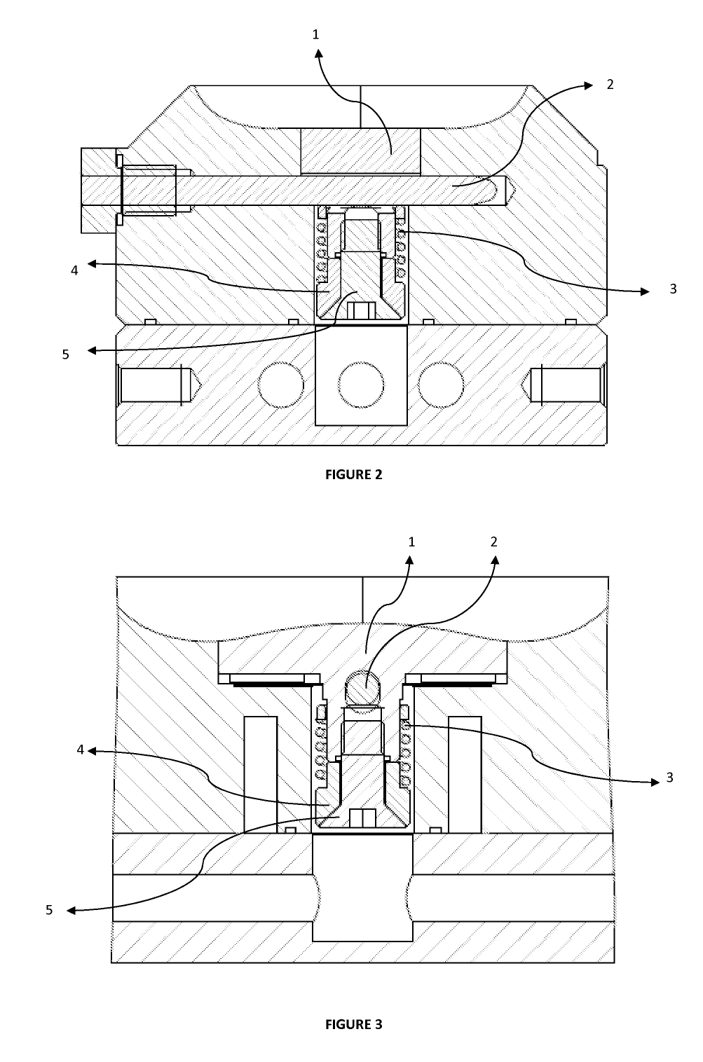

### DETAILED DESCRIPTION OF THE INVENTION

The objective of this invention, to quickly change the pneumatic ejection device of soap bars from the matrix, is achieved by making it possible to remove the ejector without removing the matrix from the stamping machine, by simply releasing the cross bolt and injecting pressurized air, as usually done by the machine, in order to eject it, this way the ejector can be removed and cleaned or replaced and another ejector can be inserted into its housing along with the cross bolt, making the machine functional once again, avoiding wasted time, risks of accidents during handling and preserving the integrity of the matrix.

In all of the figures, the numbers that are referenced indicate similar or corresponding elements.

As is seen in all of the figures, the operating principle of this system is that when the pressure-injected air pushes the ejector (1) outward to eject the bar of soap, through the cover (4) held by the screw (5) the spring (3) is compressed against the cross bolt (2), when the system is depressurized, the spring (3) retracts the system to its original position.

Having described and specified the nature and scope of the invention and the procedure to follow, we claim the right to have exclusive rights and property:

1) PNEUMATIC SOAP BAR EJECTOR QUICK CHANGE SYSTEM FROM MATRIX, characterized by the fact that it includes a cross bolt that holds or releases the pneumatic ejector, which is placed just below the external side of the ejector, this ejects and stamps the soap bar after being molded, and is placed over the spring of the holding cover and the set screw. This system's operation involves the following: when the pressure injected air pushes the ejector outward to eject the bar of soap, through the cover set by the screw the spring compresses against the cross bolt, and when the system is depressurized, the spring returns the system to its original position.

2) PNEUMATIC SOAP BAR EJECTOR QUICK CHANGE SYSTEM FROM MATRIX, claimed in section 1 characterized because in order to remove the ejection device, made up of the ejector, its spring, cover and set screw, only the cross bolt has to be removed, releasing the system, and only leaves having to inject compressed air, either through the stamping machine or manually, so that the device or devices are ejected from their housings.

3) PNEUMATIC SOAP BAR EJECTOR QUICK CHANGE SYSTEM FROM MATRIX, claimed in section 1 characterized because the cross bolt acts as a safety measure, since if the screw was to become loose it keeps each ejector connected to its spring and holding cover, said bolt keeps the ejectors held in their respective housing and the rest of the parts remain in the air chamber.
